(19) United States
(12) Patent Application Publication
(10) Pub. No.: US 2014/0095696 A1
(43) Pub. Date: Apr. 3, 2014

(54) EVALUATING UTILIZATION OF ONE OR MORE COMPUTER SYSTEMS

(71) Applicant: EMERSON ELECTRIC CO., St. Louis, MO (US)

(72) Inventors: Paul Sala, St. Louis, MO (US); Mark Mense, St. Louis, MO (US); Ryan Matovich, Wentzville, MO (US); Vadim Panfilov, St. Louis, MO (US)

(73) Assignee: EMERSON ELECTRIC CO., St. Louis, MO (US)

(21) Appl. No.: 13/632,796

(22) Filed: Oct. 1, 2012

(51) Int. Cl. G06F 11/34

(52) U.S. Cl. CPC G06F 11/3409
USPC 709/224

(57) ABSTRACT

A method of evaluating utilization of one or more computer systems includes monitoring utilization of a computer system for each of a plurality of time periods in a reporting period and, for each time period, assigning a numeric value based on the monitored utilization and a predefined scale of utilization ranges. The method also includes calculating an overall numeric value for the reporting period by combining the numeric values assigned to the plurality of time periods. The overall numeric value represents the utilization of the computer system during the reporting period. Additional methods and related computer systems are also disclosed.

### FIELD

The present disclosure relates to methods and systems for evaluating utilization of one or more computer systems.

### BACKGROUND

This section provides background information related to the present disclosure which is not necessarily prior art.

Most modern companies have numerous computer systems. In order to efficiently manage these systems, IT staff and management need to be able to determine several questions about computer system capacity such as whether the computer systems have enough capacity, what impacts changes in system usage will have on system capacity, and how remediation efforts should be prioritized across numerous computer systems and locations.

Some commercial IT system monitoring tools provide access to raw capacity data, or detailed utilization statistics over time, in tabular format or using charts or graphs. Other commercial IT systems configure monitoring tools to issue alerts when system utilization increases over a specified threshold. Some commercial IT system monitoring methods require staff members to manually review raw utilization data periodically or on an ad hoc basis. Others use automated statistical analysis by performing an in-depth analysis of raw data to develop statistical models to implement automated analysis of utilization.

### SUMMARY

This section provides a general summary of the disclosure, and is not a comprehensive disclosure of its full scope or all of its features.

According to one aspect of the present disclosure, a method of evaluating utilization of one or more computer systems is disclosed. The method includes monitoring utilization of a computer system for each of a plurality of time periods in a reporting period and, for each time period, assigning a numeric value based on the monitored utilization and a predefined scale of utilization ranges. The method also includes calculating an overall numeric value for the reporting period by combining the numeric values assigned to the plurality of time periods. The overall numeric value represents the utilization of the computer system during the reporting period.

According to another aspect of the present disclosure, a method includes monitoring utilization of a computer system for each of a plurality of time periods in a reporting period, and for each time period, assigning a numeric value based on the monitored utilization and a predefined scale of utilization ranges. The method also includes displaying the numeric values assigned to the plurality of time periods to assist an operator in evaluating the utilization of the computer system during the reporting period.

According to yet another aspect of the present disclosure, a computer system for evaluating utilization of one or more computer systems includes at least one processor, memory, and software stored in memory. The software is operable to cause the processor to monitor utilization of the monitored computer system for each of a plurality of time periods in a reporting period. For each time period, the software is operable to cause the processor to assign a numeric value based on the monitored utilization and a predefined scale of utilization ranges. The software is also operable to cause the processor to calculate an overall numeric value for the reporting period by combining the numeric values assigned to the plurality of time periods. The overall numeric value represents the utilization of the monitored computer system during the reporting period.

Further aspects and areas of applicability will become apparent from the description provided herein. It should be understood that various aspects of this disclosure may be implemented individually or in combination with one or more aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a remediation recommendation report according to one example embodiment of the present disclosure.

FIG. 2 illustrates a predictive report according to an example embodiment of the present disclosure.

FIG. 3 is a radar chart of assigned numeric values according to another example embodiment.

FIG. 4 illustrates an example available bandwidth report.

FIG. 5 is a graph illustrating the effects of utilization on latency in one example computer system.

FIG. 6 depicts an example of converting an overall numeric value for a computer system to a normalized overall numeric value on a common scale.

FIG. 7 is a block diagram of a computer system for evaluating utilization of one or more computer systems according to another example embodiment of the present disclosure.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

According to one aspect of the present disclosure, a method of evaluating utilization of one or more computer systems is disclosed. The method includes monitoring utilization of a computer system for each of a plurality of time periods in a reporting period. For each time period, the method includes assigning a numeric value based on the monitored utilization and a predefined scale of utilization ranges. The method also includes calculating an overall numeric value for the reporting period by combining the numeric values assigned to the plurality of time periods. The overall numeric value represents the utilization of the computer system during the reporting period.

Utilization may be expressed as a percentage, and may indicate the percentage use of a computer system relative to the total capacity of the computer system. The utilization may represent any attribute of computer system performance, such as network bandwidth. The utilization may be a measurement of how much a network is used during a specific time period, which may be specified as a percentage of network bandwidth capacity. A network utilization at a given time interval may determine how much more data can be transferred on a given circuit over that time interval. Inbound and/or outbound traffic of a computer system may be monitored. The method may be fully automated, and the one or more computer systems may be IT systems. The method may evaluate system capacity in a heterogeneous environment, and may not require complex statistical analysis or manual interpretation of the results.

Utilization of a computer system may be monitored using any suitable techniques or monitoring tools for monitoring any attribute of computer system performance.

Each time period is assigned a numeric value based on the monitored utilization of the computer system during that time period. The monitored utilization may be compared to a predefined scale of utilization ranges. The numeric value may be assigned by determining which predefined scale range the monitored utilization value is located in and assigning the numeric value that corresponds to that scale range.

Numeric values may be combined using any suitable techniques, such as averaging the numeric values for each time period. The overall numeric value may also be a sum of the numeric values for each time period. The calculated overall numeric value may represent the utilization of the computer system for the entire reporting period.

Time periods may be days, and the reporting periods may be weeks, a month, three months, etc. The reporting period is preferably sufficiently large to mask daily fluctuations in utilization. For some computer systems, a ninety day window may be appropriate. A shorter reporting period, such as thirty days, may be used in computer systems with a high rate of growth.

Monitoring may include monitoring a utilization of a computer system for each of a plurality of intervals in each time period. Assigning may include assigning to each time period a numeric value based on the monitored utilization during one or more of the intervals of such time period. An interval may be any amount of time less than a time period. Therefore, a time period may have any desired number of intervals within the time period. Utilization may be measured once during an interval, measured at a certain frequency during an interval, or measured continuously during an interval. If more than one measurement is made during an interval, the measurements may be combined using any suitable techniques, such as averaging, to give a single utilization for the interval. The utilization during an interval may be used to assign a numeric value to the time period that contains the interval. Alternatively, the utilization from more than one interval may be used to assign a numeric value to the time period that contains the intervals. If the utilization of more than one interval is used, the utilizations from the multiple intervals may be combined using any suitable techniques, such as averaging. Therefore, the numeric value assigned to a time period may represent only the utilization of the computer system during one or more intervals of the time period, and not the utilization of the computer system during the entire time period.

Assigning may include assigning to each time period a numeric value based on monitored utilization of one or more intervals having the greatest utilization during such time period. The utilization during each of the intervals may be compared to determine which interval has the greatest utilization. A numeric value may be assigned to each time period based on the monitored utilization of only one of the intervals having the greatest utilization during such time period. The single interval having the greatest utilization may be used for assigning a numeric value to the time period that contains such interval. Alternatively, a numeric value may be assigned to each time period based on an average of the monitored utilization of multiple intervals having the greatest utilization during such time period. The multiple intervals may be two, three, or more intervals having the greatest utilization. The multiple intervals having the greatest utilization may be averaged and the average utilization of the selected intervals may be used for assigning a numeric value to the time period that contains such multiple intervals. The multiple intervals may be multiple consecutive intervals, such that the intervals occur consecutively in time. Alternatively, the multiple intervals may be separate intervals within the time period that are not consecutive in time.

Intervals may be between about fifteen minutes and about one hour. Lightly-utilized computer systems may exhibit utilization spikes that do not impact the overall user experience and process performance. If reports are made on each spike, reporting may quickly become overcomplicated and prone to false positives. Preferably, an average utilization over a longer interval is used. The interval is preferably based on the total amount of time that the business can tolerate insufficient capacity. Some processes are impacted only when a computer system is over-utilized for a sufficiently long time period, so hourly utilization intervals may be used in these situations. When measuring utilization of highly sensitive systems, such as credit-card processing systems in large banks, higher precision may be used, such as a fifteen minute interval. Preferably, multiple samples of utilization are taken over an hourly period and averaged.

The time period may be days and the numeric value assigned to each day may be assigned based on the busiest hour of the day, or the hour having the greatest utilization. Under this approach, the numeric value assigned to a day would represent the greatest hourly utilization for the day. Alternatively, the numeric value assigned to each day may be based on the average utilization over the N hours of the day having the greatest utilization. The number of hours N may be selected based on the desired level of measurement precision. The N hours may or may not be continuous hours of the day. These approaches may produce numeric values with a reasonable degree of accuracy.

The method may further include comparing the overall numeric value for the reporting period to one or more thresholds to determine whether remediation of the computer system is recommended or required. Remediation of the computer system may include any steps or changes to be implemented to reduce the utilization of the computer system, such as by distributing the utilization more evenly across time periods or intervals, or upgrading the capacity of the computer system. Recommendations may include taking steps to ensure that only appropriate business traffic is allowed access to the network, such as putting web controls in place to limit or restrict Internet streaming media. Recommendations may include optimizing use of the computer system, such as scheduling large jobs to only run on “off hours” or adding additional hardware to do caching and compression. This may be helpful where large or repetitive files are being sent across the computer system. It may be necessary to upgrade the computer system if efforts to control or optimize the computer system utilization will not meet capacity requirements for the computer system. For example, a computer system may be upgraded to provide more bandwidth.

Multiple thresholds may be used to indicate different levels of recommended remediation. If the overall numeric value is below a first threshold, no remediation may be recommended. If the overall numeric value is above a first threshold but below a second threshold, the computer system may be considered a potential remediation candidate. If the overall numeric value is above a second threshold but below a third threshold, remediation may be recommended for the computer system. If the overall numeric value is above a third threshold, remediation may be required for the computer system.

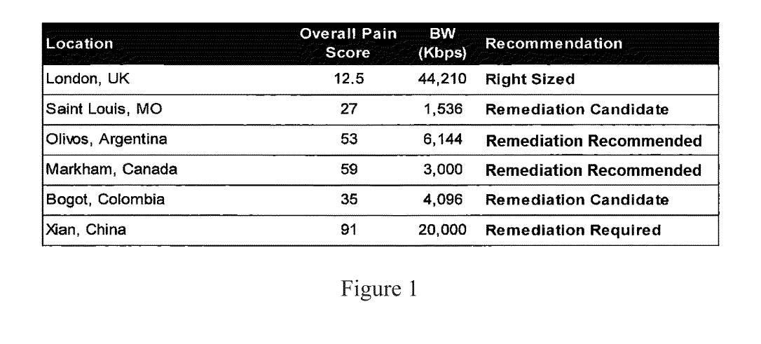

The results of the method may be reported in a format that an audience can understand and does not require interpretation using special technical skills. Preferably, the results may be reported in a simple, concise and actionable manner. A sample recommendation chart for several systems is shown in FIG. 1, which may allow customers that use a computer system to quickly review and prioritize remediation activities across numerous computer systems. The location of the computer system is listed in column 1 for identification, the overall numeric value (referred to as a “pain score”) is listed in column 2 as generated using the method, computer system network total bandwidth is listed in column 3, and a remediation recommendation is listed in column 4 based on the overall numeric values listed in column 2. For this example, no remediation is recommended below a threshold of 25, a potential remediation candidate is indicated between thresholds of 25 and 50, remediation is recommended between thresholds of 50 and 75, and remediation is required above a threshold of 75.

Monitoring may include monitoring a plurality of computer systems including a first computer system and a second computer system. Calculating may include calculating a first overall numeric value for the first computer system and calculating a second overall numeric value for the second computer system. The first overall numeric value may be compared to a first threshold to determine whether remediation of the first computer system is recommended or required, and the second overall numeric value may be compared to a second threshold to determine whether remediation of the second computer system is recommended or required. Different computer systems may use different thresholds for determining when remediation should be recommended or required. The different thresholds may be determined based on the location or type of each computer system. For example, computer systems in location A may have remediation recommended when the overall numeric value exceeds 1; while computer systems in location B may not have remediation recommended until the overall numeric value exceeds 2. As another example, computer systems of type A may have remediation recommended when the overall numeric value exceeds 1, while computer systems of type B may require remediation when the overall numeric value exceeds 1. This allows recommendations to be adapted to the type or location of a computer system by using different thresholds for the recommendations for different computer systems.

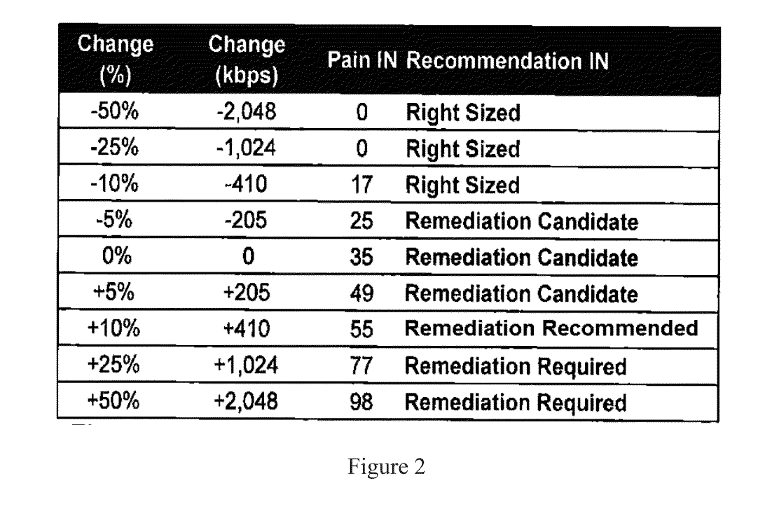

FIG. 2 depicts a sample report that allows customers that use a computer system to understand the potential impacts of possible future changes in computer system utilization to proactively plan remedial actions. FIG. 2 shows predictions of the resulting overall numeric value for a computer system if the utilization were to change from its current value. Predictions are made for utilization changes at different levels over a range from decreasing by 50% utilization to increasing by 50% utilization. This allows the customers that use the computer network to determine what the effect on the computer system will be for a variety of possible future changes in utilization of the computer system.

Supporting data may also be provided so that staff members can review each computer system in more detail. If supporting data is provided, the supporting data should preferably be provided in a manner that makes it understandable by staff members that are inexperienced with the technology of the computer system. For example, instead of providing detailed network utilization statistics to customers who use a computer system, supporting data may provide an available capacity metric modified to account for system performance impacts of overutilization. Router health data may also be provided with information concerning CPU and memory utilization. A router's CPU and Memory resources preferably should remain below 70% utilization for maximum performance, to help ensure that the router will continue to forward packets with no delay.

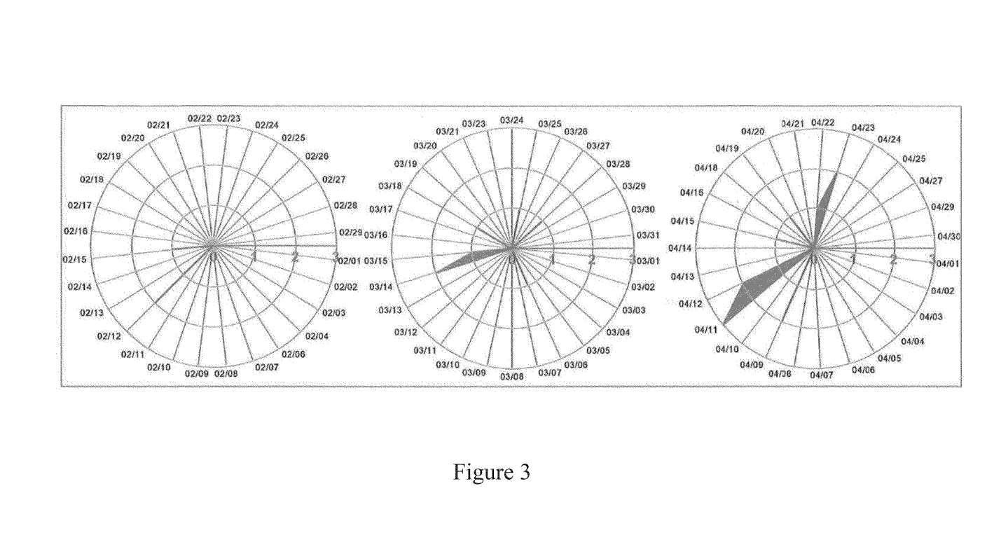

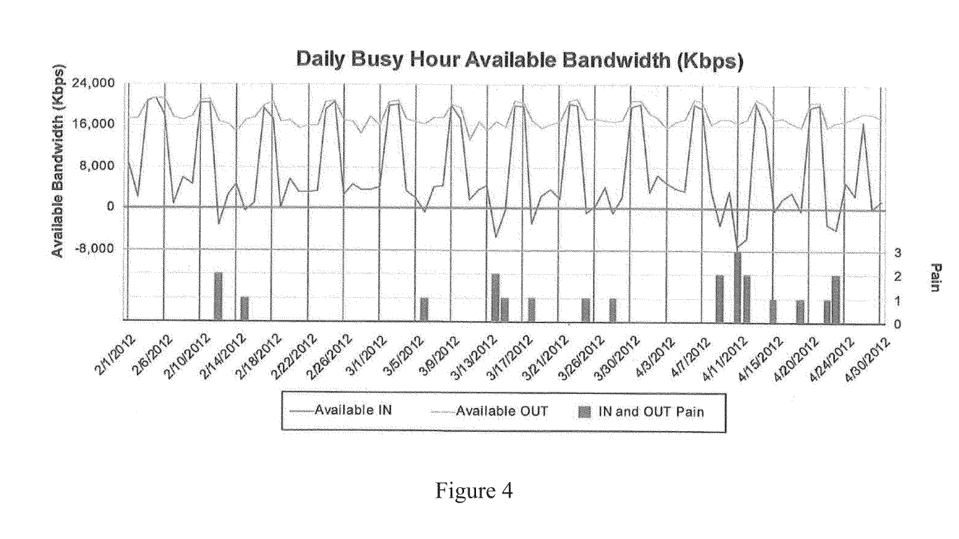

The method may also include displaying the numeric values assigned to the plurality of time periods. The numeric values assigned to the plurality of time periods may be displayed in any suitable format, such as graphs or charts, including radar charts, bar graphs, or line graphs. The numeric values may be plotted consecutively to assist a computer system administrator in reviewing each time period in the reporting period. Alternatively, only numeric values for selected time periods within the reporting period may be displayed. FIG. 3 is an example display of assigned numeric values for 90 days in three radar charts, from February 1 through April 30 (i.e., one radar chart for each month). FIG. 4 is an example display of assigned numeric values (and available bandwidth) for the same time period as FIG. 3 in a bar graph.

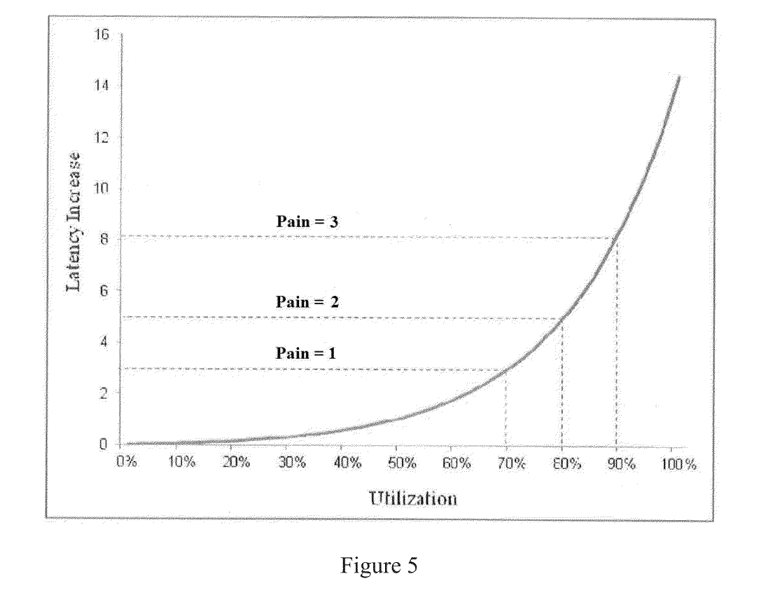

The predefined scale may include a first utilization range in which users perceive substantially no latency. Computer system network latency typically increases exponentially with increased utilization, as shown in FIG. 5. In one example computer system, at 70% utilization some users may begin to notice degradation in service due to increased latency. This may indicate that a capacity limit is beginning to be reached. Preferably, a first utilization range from about 0% to 70% utilization indicates that users will perceive substantially no latency.

The predefined scale may include no more than four utilization ranges. Using a small number of utilization ranges for the predefined scale facilitates simplicity of evaluation during review, whereas a substantially greater number of utilization ranges may lead to unnecessary complexity. The utilization ranges may include a first range of about zero to 70% utilization, a second range of about 70% to 80% utilization, a third range of about 80% to 90% utilization, and a fourth range of about 90% to 100% utilization. The utilization ranges may be selected based on the level of impact that insufficient capacity or increased utilization has on business processes. The results of the method may not be very sensitive to the thresholds used for the predefined scale ranges. A reasonable accuracy may be achieved by selecting utilization range thresholds based on generic guidelines accepted throughout the IT industry. It may be unnecessary to use precise thresholds obtained only via detailed testing and modeling for each individual computer system.

Assigning may include assigning a numeric value of zero if a monitored utilization falls within the first range of about zero to 70% utilization, assigning a numeric value of one if the monitored utilization falls within the second range of about 70% to 80% utilization, assigning a numeric value of two if the monitored utilization falls within the third range of about 80% to 90% utilization, and assigning a numeric value of three if the monitored utilization falls within the fourth range of about 90% to 100% utilization. FIG. 5 shows an example scale of four utilization ranges, using the thresholds and assigned numeric values as described above, compared to the latency that can be expected in a particular system. The assigned numeric value is referred to as a ‘pain score’ because it may represent the level of ‘pain’ that users of the computer system experience as the utilization increases, causing the latency to also increase. This ‘pain score’ may make it easier for IT system users to understand the results of method, to evaluate and review the computer system utilization, and to explain the impacts of insufficient capacity on business processes and IT system users.

Monitoring may include monitoring a plurality of computer systems including a first computer system and a second computer system. Assigning may include assigning a first numeric value to the first computer system based on a first predefined scale of utilization ranges and assigning a second numeric value to the second computer system based on a second predefined scale of utilization ranges. Different scales may be applied to different computer systems, depending on the type and location of the computer system. The scales may have a different number of scale ranges, or the values of the ranges may be different. For example, computer systems in location A may use a scale having 3 utilization ranges, while computer systems in location B may use a scale having 4 utilization ranges. As another example, computer systems of type A may use a scale having two utilization ranges from zero to 50% utilization and 50% to 100% utilization, while computer systems of type B may use a scale having two utilization ranges of zero to 75% utilization and 75% to 100% utilization.

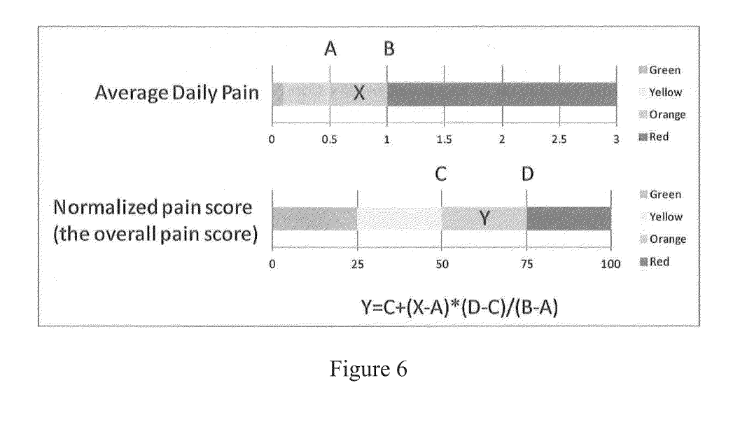

Calculating may include converting a first overall numeric value for a first computer system to a common scale and converting a second overall numeric value for a second computer system to the common scale to compare the first and second computer systems. Converting the overall numeric values to a common scale allows for direct comparison between different computer systems that may use different predefined scales of utilization ranges. The overall numeric values for each computer system may be normalized to a single common scale. The overall numeric values for each computer system may be normalized when used to report capacity or utilization to customers that use a computer system. For example, an overall numeric value based on a predefined scale of utilization having numeric values from zero to 3 may be converted to a normalized common scale of zero to 100, as shown in FIG. 6. The normalized or common scale may use any other suitable range, such as zero to ten. The overall numeric value may be converted using any calculation techniques such as the equation in FIG. 6. If another computer system has an overall numeric value based on a predefined scale of utilization having numeric values from zero to 4, it may also be converted to a normalized common scale of zero to 100.

Converting overall numeric values to a normalized or common scale may allow an operator to easily compare utilization between two networks having different predefined scales of utilization. The overall numeric values for each computer system may be normalized when used to report capacity or utilization to customers that use a computer system. Converting overall numeric values to a normalized value or common scale may make it easier for users to understand the system utilization and/or compare across systems with different criticality and usage patterns, and also across different time intervals. A normalized overall numeric value may allow for the comparison of computer systems with different utilization and latency tolerances and may allow the use of different thresholds for different recommendation levels.

Monitoring may include monitoring available bandwidth of a computer system relative to a latency threshold value to determine when the network is operating with user perceivable latency. As shown in FIG. 5, latency increases as computer system utilization increases. At some threshold, the latency increases to the point that users will perceive the latency. This is designated as level 1 in FIG. 5, and corresponds to 70% utilization.

In a computer system, the percentage utilization may correspond to percentage of use of the maximum bandwidth capacity of the system. An available bandwidth metric may be defined as a latency threshold value of utilization minus the actual utilization percentage of the computer system. A latency threshold value may be the percentage of used bandwidth at which users start to perceive latency on the network. The latency threshold value may be 70% of the maximum bandwidth of the computer system. As utilization increases, available bandwidth decreases. If available bandwidth decreases below the threshold, users will perceive increased latency. If available bandwidth is increased above this threshold, users will no longer perceive latency. The available bandwidth metric may be positive when utilization is below the latency threshold and negative when utilization is above the latency threshold.

Referring again to FIG. 4, the zero level of available bandwidth is the latency threshold, below which users will perceive latency. For any time periods in which available bandwidth decreases below the latency threshold, a numeric value is assigned to the time period based on a predetermined scale of utilization ranges. This allows an operator to determine when the network is operating with user perceivable latency. An available bandwidth percentage may also be calculated on a daily basis as the latency threshold value of utilization minus the utilization during the busiest hour of the day. Both inbound and outbound traffic of a computer system may be monitored.

According to another aspect of the present disclosure, a method of evaluating utilization of one or more computer systems includes monitoring utilization of a computer system for each of a plurality of time periods in a reporting period. For each time period, the method includes assigning a numeric value based on the monitored utilization and a predefined scale of utilization ranges. The method also includes displaying the numeric values assigned to the plurality of time periods to assist an operator in evaluating the utilization of the computer system during the reporting period.

The numeric values assigned to the plurality of time periods may be displayed in any format, such as any conventional graphs or charts, including radar charts, bar graphs, or line graphs. The numeric values may be plotted consecutively to assist a computer system administrator in reviewing every time period in the reporting period. Alternatively, only numeric values for selected time periods within the reporting period may be displayed. As noted above, FIG. 3 is an example display of assigned numeric values for 90 days in three radar charts, from February 1 through April 30, and FIG. 4 is an example display of assigned numeric values for the same time period as FIG. 3 in a bar graph.

Displaying the numeric values for each of a plurality of time periods, in addition to or instead of calculating an overall numeric value for the reporting period, allows an operator to evaluate trends in utilization throughout the reporting period to more accurately determine points of greater and lesser utilization during the reporting period. This may assist the operator in evaluating whether the utilization is consistent throughout the reporting period, or whether there is large variation in utilization during the reporting period. The operator may be able to determine when to block high utilization activities, how to distribute the utilization more evenly throughout the reporting period, or which time periods should be used for scheduling high utilization activities in the future. Additionally, the display may assist the operator in determining the cause of overutilization of the computer system.

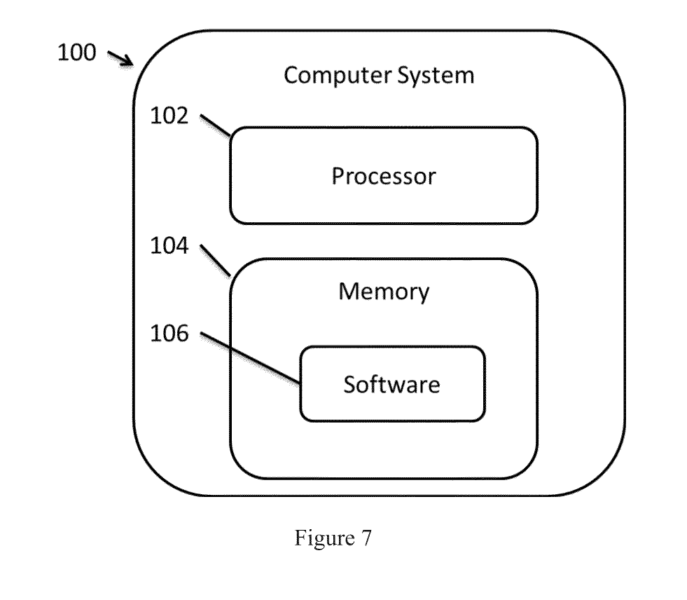

FIG. 7 illustrates a computer system 100 for evaluating utilization of one or more computer systems. The computer system 100 includes at least one processor 102, memory 104, and software 106 stored in memory. The software 106 is operable to cause the processor 102 to monitor utilization of a monitored computer system for each of a plurality of time periods in a reporting period. For each time period, the software 106 is operable to cause the processor to assign a numeric value based on the monitored utilization and a predefined scale of utilization ranges. The software 106 is also operable to cause the processor to calculate an overall numeric value for the reporting period by combining the numeric values assigned to the plurality of time periods, with the overall numeric value representing the utilization of the monitored computer system during the reporting period. Additionally, or alternatively, the computer system 100 may be configured to implement one or more of the methods disclosed herein.

It should be understood that the system 100 may be implemented in various ways. For example, the system 100 may be implemented on a personal computer, an office network, or one or more servers. The system 100 may be implemented using a single processor 102, multiple processors on a single system, or multiple processors across systems that may be in a local or a distributed system. Additionally, the memory 104 may be memory located on a single computer, a server, or shared between multiple systems. The memory 104 may be located within the same system as one or more of the processors 102 (including onboard memory in the processors), or may be located externally. The memory 104 may be random access memory or more permanent data storage memory, such as a hard drive. The software 106 may be stored in any location in the memory 104 and may or may not be stored in the same memory. The software 106 may be stored in memory 104 on a single computer, a server, or may be shared between multiple systems. The monitored computer system may be the computer system 100. Alternatively, the monitored computer system may be separate from the computer system 100.

The above methods may produce results with reasonable degrees of accuracy if used over an extended period of time, such as thirty days or more. The methods may not be very sensitive to thresholds, such that threshold deviations of plus or minus 5% may be acceptable in many cases. These methods may be easier to understand by both IT and non-IT staff, and may be easier to implement. The methods may make it easier for customers to understand the impacts of capacity overutilization, and may make it easier to adopt the methodology throughout an entire computer system environment. The results of these methods may be reported in a fully automated manner, and may produce consistent results. If automation is not available due to cost/benefit considerations, IT staff with different levels of experience may create a report based on this method. These methods may be applied to computer systems with different utilization patterns, different criticality, and with different impacts of overutilization on performance. Threshold selection may be a relatively simple task when using these methods and the methodology may be easily understood by individuals with various levels of experience with IT systems. Normalized metrics may be used to develop recommendations that allow customers to prioritize remediation efforts. These methods may provide an uncomplicated methodology, with repeatable and consistent results, that is easy to implement, provides scalable and accurate reporting, interpreted information, concise and actionable answers, and has visibility and prioritization across computer systems. These systems and methods may be implemented using any IT measurement and monitoring tools that provide the ability to monitor and report on IT system capacity.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of evaluating utilization of one or more computer systems, the method comprising:
monitoring utilization of a computer system for each of a plurality of time periods in a reporting period;
for each time period, assigning a numeric value based on the monitored utilization and a predefined scale of utilization ranges; and
calculating an overall numeric value for the reporting period by combining the numeric values assigned to the plurality of time periods, the overall numeric value representing the utilization of the computer system during the reporting period.

2. The method of claim 1 wherein monitoring includes monitoring the utilization of the computer system for each of a plurality of intervals in each time period, and wherein assigning includes assigning, to each time period, the numeric value based on the monitored utilization during one or more of the intervals of such time period.

3. The method of claim 2 wherein assigning includes assigning, to each time period, the numeric value based on the monitored utilization of one or more of the intervals having the greatest utilization during such time period.

4. The method of claim 3 wherein assigning includes assigning, to each time period, the numeric value based on the monitored utilization of only one of the intervals having the greatest utilization during such time period.

5. The method of claim 3 wherein assigning includes assigning, to each time period, the numeric value based on an average of the monitored utilization of multiple intervals having the greatest utilization during such time period.

6. The method of claim 5 wherein said multiple intervals are multiple consecutive intervals.

7. The method of claim 3 wherein the time periods are days and the reporting period is at least one week.

8. The method of claim 7 wherein the intervals are between about fifteen minutes and about one hour.

9. The method of claim 1 further comprising comparing the overall numeric value for the reporting period to one or more thresholds to determine whether remediation of the computer system is recommended or required.

10. The method of claim 1 further comprising displaying the numeric values assigned to the plurality of time periods.

11. The method of claim 10 wherein displaying includes displaying the numeric values assigned to the plurality of time periods as a radar chart.

12. The method of claim 1 wherein the predefined scale includes a first utilization range in which users perceive substantially no latency.

13. The method of claim 1 wherein the predefined scale includes no more than four utilization ranges.

14. The method of claim 13 wherein the utilization ranges include a first range of about zero to 70% utilization, a second range of about 70% to 80% utilization, a third range of about 80% to 90% utilization, and a fourth range of about 90% to 100% utilization.

15. The method of claim 14 wherein assigning includes assigning a numeric value of zero if the monitored utilization falls within the first range of about zero to 70% utilization, assigning a numeric value of one if the monitored utilization falls within the second range of about 70% to 80% utilization, assigning a numeric value of two if the monitored utilization falls within the third range of about 80% to 90% utilization, and assigning a numeric value of three if the monitored utilization falls within the fourth range of about 90% to 100% utilization.

16. The method of claim 1 wherein monitoring includes monitoring a plurality of computer systems including a first computer system and a second computer system, wherein assigning includes assigning a first numeric value to a first computer system based on a first predefined scale of utilization ranges and assigning a second numeric value to a second computer system based on a second predefined scale of utilization ranges, and wherein calculating includes converting a first overall numeric value for the first computer system to a common scale and converting a second overall numeric value for the second computer system to the common scale to compare the first and second computer systems.

17. The method of claim 9 wherein monitoring includes monitoring a plurality of computer systems including a first computer system and a second computer system, wherein calculating includes calculating a first overall numeric value for the first computer system and calculating a second overall numeric value for the second computer system, and wherein comparing includes comparing the first overall numeric value to a first threshold to determine whether remediation of the first computer system is recommended or required and comparing the second overall numeric value to a second threshold to determine whether remediation of the second computer system is recommended or required.

18. The method of claim 1 wherein monitoring includes monitoring available bandwidth of the computer system relative to a latency threshold value to determine when the network is operating with user perceivable latency.

19. A method of evaluating utilization of one or more computer systems, the method comprising:
monitoring utilization of a computer system for each of a plurality of time periods in a reporting period;
for each time period, assigning a numeric value based on the monitored utilization and a predefined scale of utilization ranges; and
displaying the numeric values assigned to the plurality of time periods to assist an operator in evaluating the utilization of the computer system during the reporting period.

20. A computer system for evaluating utilization of one or more computer systems, the computer system comprising:
at least one processor;
memory; and
software stored in memory and operable to cause the processor to monitor utilization of the monitored computer system for each of a plurality of time periods in a reporting period;
for each time period, the software operable to cause the processor to assign a numeric value based on the monitored utilization and a predefined scale of utilization ranges; and
the software operable to cause the processor to calculate an overall numeric value for the reporting period by combining the numeric values assigned to the plurality of time periods, the overall numeric value representing the utilization of the monitored computer system during the reporting period.
